(19) United States
(12) Patent Application Publication
(10) Pub. No.: US 2012/0198106 A1
(43) Pub. Date: Aug. 2, 2012

(54) Method Of Processing Requests For Hardware And Multi-Core System

(75) Inventor: Jin-Sung YANG, Yongin-si (KR)

(73) Assignee: SAMSUNG ELECTRONICS CO., LTD., Suwon-si (KR)

(21) Appl. No.: 13/348,967

(22) Filed: Jan. 12, 2012

(30) Foreign Application Priority Data
Feb. 1, 2011 (KR) 10-2011-0010200

(51) Int. Cl. G06F 3/00

(52) U.S. Cl. 710/39; 710/36

(57) ABSTRACT

In a method of processing requests for hardware in a multi-core system including a first processor core and a second processor core according to example embodiments, the first processor core receives a plurality of hardware input/output requests from a plurality of applications, manages the plurality of hardware input/output requests using a hardware input/output list, and responds to the plurality of hardware input/output requests in a non-blocking manner. The second processor core sequentially processes the plurality of hardware input/output requests included in the hardware input/output list.

### CROSS-REFERENCE TO RELATED APPLICATIONS

This U.S. non-provisional application claims the benefit of priority under 35 U.S.C. §119 to Korean Patent Application No. 2011-0010200 filed on Feb. 1, 2011 in the Korean Intellectual Property Office (KIPO), the entire contents of which is are incorporated herein by reference.

### BACKGROUND

1. Technical Field

Example embodiments relate to computing systems. More particularly, example embodiments relate to methods of processing requests for hardware and multi-core systems.

2. Description of the Related Art

A computing system includes a limited number of hardware devices or peripheral devices because of a cost, a spatial limitation, etc. Accordingly, even if the performance of a processor included in the computing system is improved, the performance of the entire computing system may be deteriorated because applications executed by the processor wait for an input/output of the limited number of hardware devices.

### SUMMARY

Some example embodiments provide a method of processing requests for hardware capable of improving a system performance.

Some example embodiments provide a multi-core system having an improved performance.

According to example embodiments, in a method of processing requests for hardware in a multi-core system including a first processor core and a second processor core, the first processor core receives a plurality of hardware input/output requests from a plurality of applications. The first processor core manages the plurality of hardware input/output requests using a hardware input/output list. The first processor core responds to the plurality of hardware input/output requests in a non-blocking manner. The second processor core sequentially processes the plurality of hardware input/output requests included in the hardware input/output list.

In some embodiments, the hardware input/output list may include a plurality of linked lists respectively corresponding to the plurality of applications, and the plurality of linked lists may be linked to one another.

In some embodiments, to manage the plurality of hardware input/output requests, if a new hardware input/output request is received from one of the plurality of applications, the new hardware input/output request may be appended to corresponding one of the plurality of linked lists.

In some embodiments, to manage the plurality of hardware input/output requests, if a new application is executed, a new linked list corresponding to the new application may be added to the plurality of linked lists.

In some embodiments, to sequentially process the plurality of hardware input/output requests, a linked list may be selected from the plurality of linked lists, a hardware input/output request included in the selected linked list may be fetched, and a hardware input/output operation corresponding to the fetched hardware input/output request may be performed.

In some embodiments, to fetch the hardware input/output request, a head of the selected linked list may be fetched, and the head of the selected linked list may be removed.

In some embodiments, fetching the hardware input/output request and performing the hardware input/output operation may be repeated until the selected linked list becomes empty.

In some embodiments, to sequentially process the plurality of hardware input/output requests, if the selected linked list becomes empty, a next linked list to which the empty linked list is linked may be selected among the plurality of linked lists.

In some embodiments, the hardware input/output list may include a first-in first-out (FIFO) queue to manage the plurality of hardware input/output requests in a FIFO manner.

In some embodiments, to manage the plurality of hardware input/output requests; if a new hardware input/output request is received, the new hardware input/output request may be appended to a tail of the FIFO queue.

In some embodiments, the plurality of hardware input/output requests may be sequentially processed according to an input order of the plurality of hardware input/output requests.

In some embodiments, to sequentially process the plurality of hardware input/output requests, the plurality of hardware input/output requests may be sequentially fetched from the FIFO queue, and hardware input/output operations corresponding to the fetched hardware input/output requests may be performed.

In some embodiments, to sequentially fetch the plurality of hardware input/output requests, a head of the FIFO queue may be fetched, and the head of the FIFO queue may be removed.

According to example embodiments, a multi-core system includes a first processor core and a second processor core. The first processor core receives a plurality of hardware input/output requests from a plurality of applications, and executes a request manager managing the plurality of hardware input/output requests using a hardware input/output list and responding to the plurality of hardware input/output requests in a non-blocking manner. The second processor core executes a resource manager sequentially processing the plurality of hardware input/output requests included in the hardware input/output list.

In some embodiments, the multi-core system may include a third processor core configured to execute another resource manager. The resource manager and the another resource manager may perform hardware input/output operations for different hardware devices.

As described above, in a method of processing requests for hardware and a multi-core system according to example embodiments, a processor core manages hardware input/output requests and another processor core processes the hardware input/output requests. Accordingly, a performance of the entire system may be improved. Further, a method of processing requests for hardware and a multi-core system according to example embodiments may allow a plurality of applications to efficiently use a limited number of hardware devices.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a flow chart illustrating a method of processing requests for hardware in a multi-core system according to example embodiments.

FIG. 2 is a block diagram illustrating a multi-core system according to example embodiments.

FIG. 3 is a flow chart illustrating an operation of a request manager included in a multi-core system of FIG. 2.

FIG. 4 is a flow chart illustrating an operation of a resource manager included in a multi-core system of FIG. 2.

FIG. 5 is a block diagram illustrating a multi-core system according to example embodiments.

FIG. 6 is a flow chart illustrating an operation of a request manager included in a multi-core system of FIG. 5.

FIG. 7 is a flow chart illustrating an operation of a resource manager included in a multi-core system of FIG. 5.

FIG. 8 is a block diagram illustrating a multi-core system according to example embodiments.

FIG. 9 is a block diagram illustrating a multi-core system according to example embodiments.

FIG. 10 is a block diagram illustrating a mobile system according to example embodiments.

FIG. 11 is a block diagram illustrating a computing system according to example embodiments.

### DETAILED DESCRIPTION OF THE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in alike fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

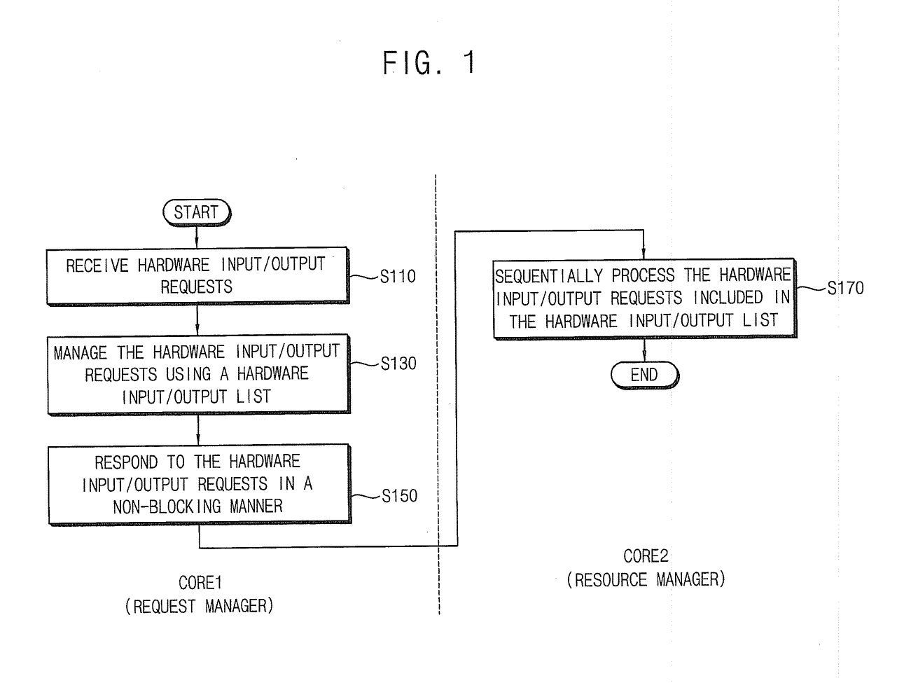

FIG. 1 is a flow chart illustrating a method of processing requests for hardware in a multi-core system according to example embodiments.

Referring to FIG. 1, a first processor core receives a plurality of hardware input/output requests from a plurality of applications (S110). Each application may be executed by the first processor core or other processor cores. For example, the plurality of applications may include, but are not limited to, an internet browser, a game application, a video player application, etc. The plurality of applications may request input/output operations for at least one hardware device. For example, the plurality of applications may request the input/output operations for hardware devices, such as a graphic processing unit (GPU), a storage device, a universal serial bus (USB) device, an encoder/decoder, etc. The first processor core may execute a request manager to receive the plurality of hardware input/output requests from the plurality of applications.

The first processor core manages the plurality of hardware input/output requests using a hardware input/output list (S130). The request manager executed by the first processor core may manage the hardware input/output list including the plurality of hardware input/output requests. In some embodiments, the hardware input/output list may include a plurality of linked lists respectively corresponding to the plurality of applications. The plurality of linked lists may be linked to one another. For example, if a new hardware input/output request is received, the request manager may append the new hardware input/output request to a tail of a linked list corresponding to an application that generates the new hardware input/output request. In other embodiments, the hardware input/output list may include a first-in first-out (FIFO) queue. For example, if a new hardware input/output request is received, the request manager may append the new hardware input/output request to a tail of the FIFO queue. In still other embodiments, the hardware input/output list may have a structure other than the linked list and the FIFO queue.

The first processor core responds to the plurality of hardware input/output requests in a non-blocking manner (S150). The request manager may not wait for the completion of hardware input/output operations corresponding to the plurality of hardware input/output requests, and may substantially immediately respond to the plurality of hardware input/output requests. Accordingly, the plurality of applications generating the plurality of hardware input/output requests may not wait for the completion of the hardware input/output operations, and may perform other operations.

A second processor core sequentially processes the plurality of hardware input/output requests included in the hardware input/output list that is managed by the first processor core (S170). The second processor core may execute a resource manager to sequentially fetch the plurality of hardware input/output requests from the hardware input/output list managed by the first processor core, and to process the fetched hardware input/output requests. In some embodiments, the hardware input/output list may include the plurality of linked lists. In this case, the resource manager may process the hardware input/output requests included in one linked list, and then may process the hardware input/output requests included in the next linked list. In other embodiments, the hardware input/output list may include the FIFO queue, and the resource manager may sequentially process the hardware input/output requests included in the FIFO queue from a head of the FIFO queue to a tail of the FIFO queue.

As described above, the first processor core performs the reception, the response and the management of the plurality of hardware input/output requests, and the second processor core that is different from the first processor core processes the hardware input/output operations corresponding to the plurality of hardware input/output requests. Accordingly, since the hardware input/output request management and the hardware input/output request process are performed in parallel by different processor cores, the hardware input/output operations are efficiently performed, and a performance of an entire system may be improved.

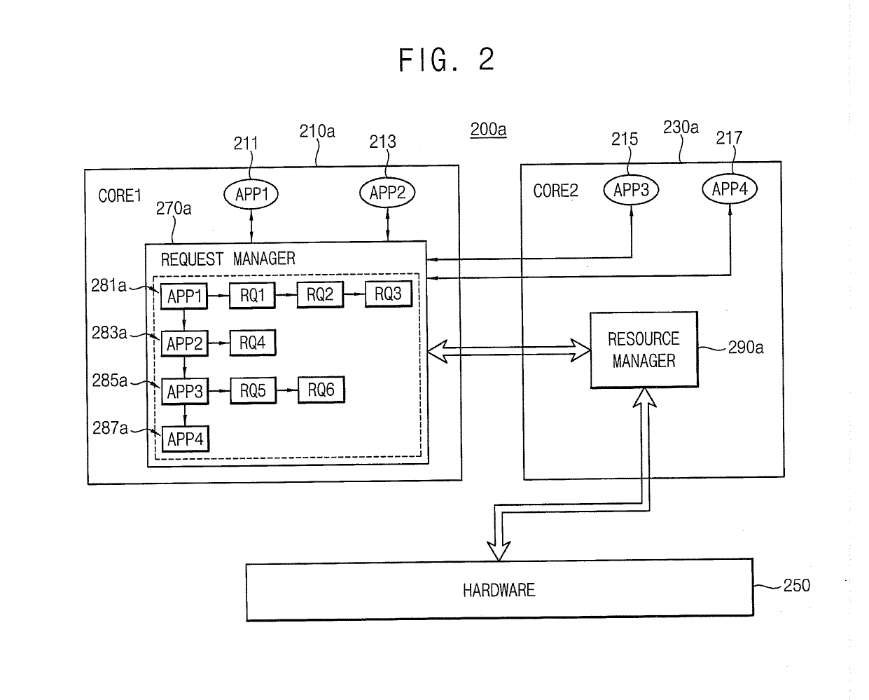

FIG. 2 is a block diagram illustrating a multi-core system according to example embodiments.

Referring to FIG. 2, a multi-core system 200a includes a first processor core 210a, a second processor core 230a and at least one hardware device 250.

The first processor core 210a and the second processor core 230a may execute a plurality of applications 211, 213, 215 and 217. For example, the first processor core 210a may execute first and second applications 211 and 213, and the second processor core 230a may execute third and fourth applications 215 and 217. For example, each of the first through fourth applications 211, 213, 215 and 217 may be one of various applications, such as an internet browser, a game application, a video player application, etc.

The first processor core 210a may execute a request manager 270a that communicates with the first through fourth applications 211, 213, 215 and 217. The request manager 270a may receive hardware input/output requests from the first through fourth applications 211, 213, 215 and 217, and may respond to the hardware input/output requests in a non-blocking manner. The request manager 270a may include a hardware input/output list 280a to manage the hardware input/output requests received from the hardware input/output requests.

The hardware input/output list 280a may include first through fourth linked lists 281a, 283a, 285a and 287a respectively corresponding to the first through fourth applications 211, 213, 215 and 217. For example, the first linked list 281a may include first through third hardware input/output requests RQ1, RQ2 and RQ3 received from the first application 211, the second linked list 283a may include a fourth hardware input/output request RQ4 received from the second application 213, the third linked list 285a may include fifth and sixth hardware input/output requests RQ5 and RQ6 received from the third application 215, and the fourth linked list 287a corresponding to the fourth application 217 may be empty. The first through fourth linked lists 281a, 283a, 285a and 287a may be linked to one another in one direction or in both directions. For example, the first linked list 281a may be linked to the second linked list 283a, the second linked list 283a may be linked to the third linked list 285a, and the third linked list 285a may be linked to the fourth linked list 287a. According to example embodiments, the fourth linked list 287a may not be linked to a next linked list as a tail list, or may be linked to the first linked list 281a in a circular manner.

The second processor core 230a may execute a resource manager 290a to perform an input/output operation for the at least one hardware device 250. The resource manager 290a may sequentially fetch the hardware input/output requests RQ1, RQ2, RQ3, RQ4, RQ5 and RQ6 from the hardware input/output list 280a of the request manager 270a, and may control the hardware device 250 to perform a hardware input/output operation corresponding to the fetched hardware input/output request. For example, the resource manager 290a may control the hardware device 250, such as a GPU, a storage device, a USB device, an encoder/decoder, etc. The resource manager 290a may operate as a kernel thread that is executed independently of a kernel process. The request manager 270a may be executed by the first processor core 210a, and the resource manager 290a may be executed by the second processor core 230a. Accordingly, the hardware input/output requests RQ1, RQ2, RQ3, RQ4, RQ5 and RQ6 received from the first through fourth applications 211, 213, 215 and 217 may be managed independently of an operation of the hardware device 250. In some embodiments, if no hardware input/output request exists in the hardware input/output list 280a, the resource manager 290a may be terminated, and may be executed again when a new hardware input/output request is generated.

As described above, since the request manager 270a responds to the hardware input/output requests RQ1, RQ2, RQ3, RQ4, RQ5 and RQ6 received from the first through fourth applications 211, 213, 215 and 217 in a non-blocking manner, the first through fourth applications 211, 213, 215 and 217 may not wait for the completion of the hardware input/output operations corresponding to the hardware input/output requests RQ1, RQ2, RQ3, RQ4, RQ5 and RQ6, and may perform other operations. Further, since the request manager 270a is executed by the first processor core 210a and the resource manager 290a is executed by the second processor core 230a, the management of the hardware input/output requests and the execution of the hardware input/output operations may be processed in parallel. Accordingly, a performance of the multi-core system 200a may be improved.

The request manager 270a and the resource manager 290a may be integrally referred to as a “dynamic resource controller”. In the multi-core system 200a according to example embodiments, the dynamic resource controller may allow a plurality of applications 211, 213, 215 and 217 to efficiently use a limited number of hardware devices 250.

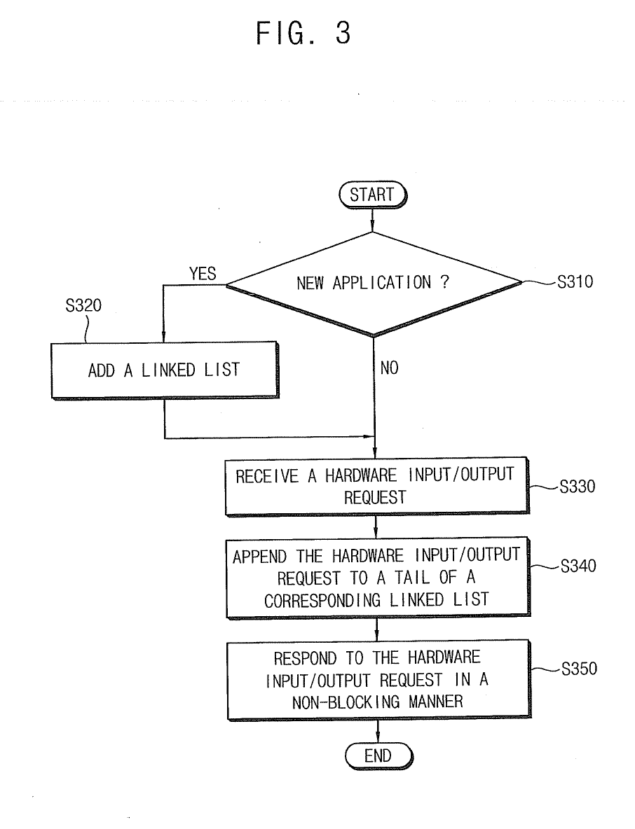

FIG. 3 is a flow chart illustrating an operation of a request manager included in a multi-core system of FIG. 2.

Referring to FIGS. 2 and 3, if a new application is executed by a first processor core 210a or a second processor core 230a (S310: YES), a request manager 270a adds a linked list corresponding to the new application to a hardware input/output list 280a (S320). For example, once first through fourth applications 211, 213, 215 and 217 are executed, the request manager 270a may manage the hardware input/output list 280a to include first through fourth linked lists 281a, 283a, 285a and 287a corresponding to the first through fourth applications 211, 213, 215 and 217. Further, if an application is terminated, the request manager 270a may remove a linked list corresponding to the terminated application from the hardware input/output list 280a.

Alternatively, the request manager 270a may add the linked list corresponding to the new application to the hardware input/output list 280a when the new application generates a hardware input/output request for the first time. Further, the request manager 270a may remove a linked list from the hardware input/output list 280a if no hardware input/output request exists in the linked list, or if the linked list becomes empty.

The request manager 270a receives hardware input/output requests RQ1, RQ2, RQ3, RQ4, RQ5 and RQ6 from the first through fourth applications 211, 213, 215 and 217 (S330). For example, the request manager 270a may receive first through third hardware input/output requests RQ1, RQ2 and RQ3 from the first application 211, a fourth hardware input/output request RQ4 from the second application 213, and fifth and sixth hardware input/output requests from the third application 215.

The request manager 270a appends the hardware input/output requests RQ1, RQ2, RQ3, RQ4, RQ5 and RQ6 to the linked lists 281a, 283a, 285a and 287a (S340). For example, the request manager 270a may sequentially append the first through third hardware input/output requests RQ1, RQ2 and RQ3 to a tail of the first linked list 281a, the fourth hardware input/output request RQ4 to a tail of the second linked list 283a, and the fifth and sixth hardware input/output requests RQ5 and RQ6 to a tail of the third linked list 285a.

The request manager 270a responds to the hardware input/output requests RQ1, RQ2, RQ3, RQ4, RQ5 and RQ6 received from the first through fourth applications 211, 213, 215 and 217 in a non-blocking manner (S350). That is, if the request manager 270a receives the hardware input/output requests RQ1, RQ2, RQ3, RQ4, RQ5 and RQ6, the request manager 270a may not wait for the completion of hardware input/output operations corresponding to the hardware input/output requests RQ1, RQ2, RQ3, RQ4, RQ5 and RQ6, and may substantially immediately respond to the first through fourth applications 211, 213, 215 and 217. Accordingly, the first through fourth applications 211, 213, 215 and 217 may perform other operations, and the first and second processor cores 210a and 230a may efficiently operate.

In some embodiments, the request manager 270a may substantially reside in the first processor core 210a, and may repeatedly perform the reception, the response and the management of the hardware input/output requests until the multi-core system 200a is terminated.

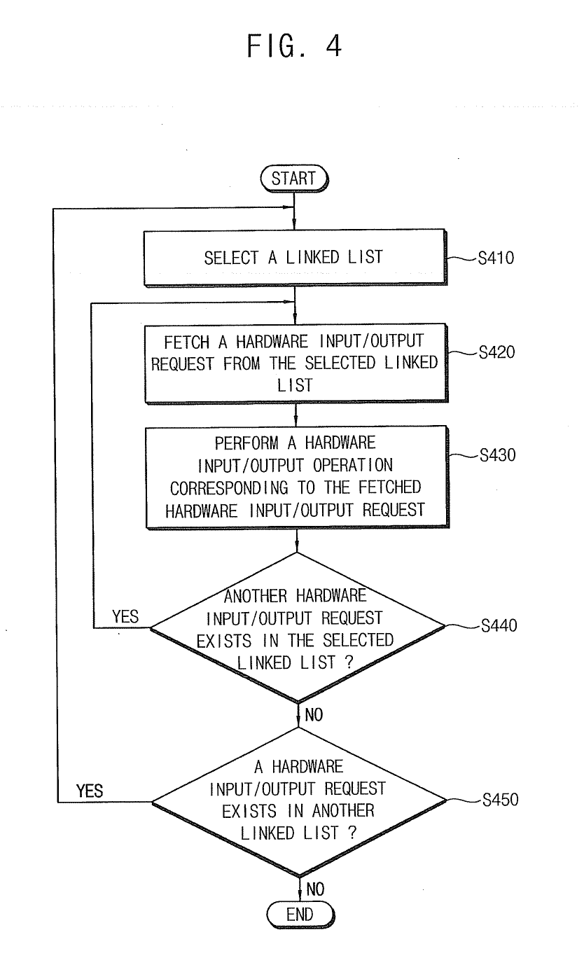

FIG. 4 is a flow chart illustrating an operation of a resource manager included in a multi-core system of FIG. 2.

Referring to FIGS. 2 and 4, a resource manager 290a selects one of a plurality of linked lists 281a, 283a, 285a and 287a included in a hardware input/output list 280a (S410). The resource manager 290a fetches a hardware input/output request from the selected linked list (S420). For example, the resource manager 290a may select a first liked list 281a corresponding to a first application 281a among first through fourth linked lists 281a, 283a, 285a and 287a, and may sequentially fetch first through third hardware input/output requests RQ1, RQ2 and RQ3 from a head of the first liked list 281a.

The resource manager 290a controls a hardware device 250 to perform a hardware input/output operation corresponding to the fetched hardware input/output request (S430). For example, if the first linked list 281a is selected, the first hardware input/output request RQ1 located at the head of the first liked list 281a may be fetched, and a hardware input/output operation corresponding to the fetched first hardware input/output request RQ1 may be performed.

If another hardware input/output request exists in the selected linked list (S440: YES), the resource manager 290a fetches the another hardware input/output request from the selected linked list (S420), and may perform a hardware input/output operation corresponding to the fetched hardware input/output request with the hardware device 250 (S430). For example, if the hardware input/output operation corresponding to the first hardware input/output request RQ1 is performed, the second and third hardware input/output requests RQ2 and RQ3 may exist in the selected linked list, or the first linked list 281a. In this case, the resource manager 290a may fetch the second hardware input/output request RQ2, and may perform a hardware input/output operation corresponding to the second hardware input/output request RQ2. Thereafter, the resource manager 290a may fetch the third hardware input/output request RQ3, and may perform a hardware input/output operation corresponding to the third hardware input/output request RQ3.

If no hardware input/output request exists in the selected linked list (S440: NO), and a hardware input/output request exists in another linked list (S450: YES), a next list, to which the selected linked list is linked, may be selected (S410). For example, if all of the first through third hardware input/output requests RQ1, RQ2 and RQ3 included in the first linked list 281a are processed, the first linked list 281a may become empty, and the second list 283a, to which the first linked list 281a is linked, may be selected. Once the second list 283a is selected, a fourth hardware input/output request RQ4 included in the second list 283a may be processed. Thereafter, the third linked list RQ3, to which the second linked list 283a is linked, may be selected, and fifth and sixth hardware input/output requests RQ5 and RQ6 may be sequentially processed.

In some embodiments, if all of the first through sixth hardware input/output requests RQ1, RQ2, RQ3, RQ4, RQ5 and RQ6 are processed, and no hardware input/output request exists in the hardware input/output list 280a (S450: NO), the resource manager 290a may be terminated. The resource manager 290a may be executed again when a new hardware input/output request is appended to the hardware input/output list 280a. In other embodiments, the resource manager 290a may substantially reside in the second processor core 230a, and may be terminated when the multi-core system 200a is terminated.

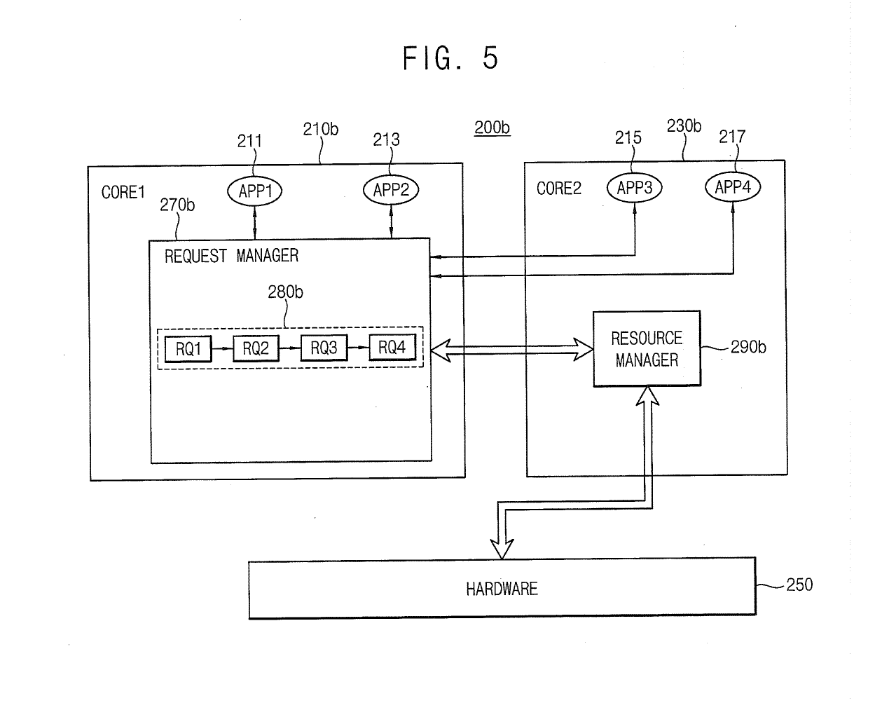

FIG. 5 is a block diagram illustrating a multi-core system according to example embodiments.

Referring to FIG. 5, a multi-core system 200b includes a first processor core 210b, a second processor core 230b and at least one hardware device 250.

The first processor core 210b and the second processor core 230b may execute first through fourth applications 211, 213, 215 and 217. The first processor core 210b may execute a request manager 270b that communicates with the first through fourth applications 211, 213, 215 and 217. The request manager 270b may respond to hardware input/output requests RQ1, RQ2, RQ3 and RQ4 received from the first through fourth applications 211, 213, 215 and 217 in anon-blocking manner. The request manager 270b may include a hardware input/output list 280b to manage the hardware input/output requests RQ1, RQ2, RQ3 and RQ4.

The hardware input/output list 280b may include a FIFO queue for managing the hardware input/output requests RQ1, RQ2, RQ3 and RQ4 in a FIFO manner. For example, the request manager 270b may sequentially append first through fourth hardware input/output requests RQ1, RQ2, RQ3 and RQ4 to the FIFO queue according to an input order of the first through fourth hardware input/output requests RQ1, RQ2, RQ3 and RQ4 regardless of which application generates each hardware input/output request.

The second processor core 230b may execute a resource manager 290b to perform an input/output operation for the at least one hardware device 250. The resource manager 290b may sequentially fetch the hardware input/output requests RQ1, RQ2, RQ3 and RQ4 from the hardware input/output list 280b of the request manager 270b, and may control the hardware device 250 to perform a hardware input/output operation corresponding to the fetched hardware input/output request.

As described above, since the request manager 270b responds to the hardware input/output requests RQ1, RQ2, RQ3 and RQ4 received from the first through fourth applications 211, 213, 215 and 217 in a non-blocking manner, the first through fourth applications 211, 213, 215 and 217 may not wait for the completion of the hardware input/output operations corresponding to the hardware input/output requests RQ1, RQ2, RQ3 and RQ4, and may perform other operations. Further, since the request manager 270b is executed by the first processor core 210b and the resource manager 290b is executed by the second processor core 230b, the management of the hardware input/output requests and the execution of the hardware input/output operations may be processed in parallel. Accordingly, a performance of the multi-core system 200b may be improved.

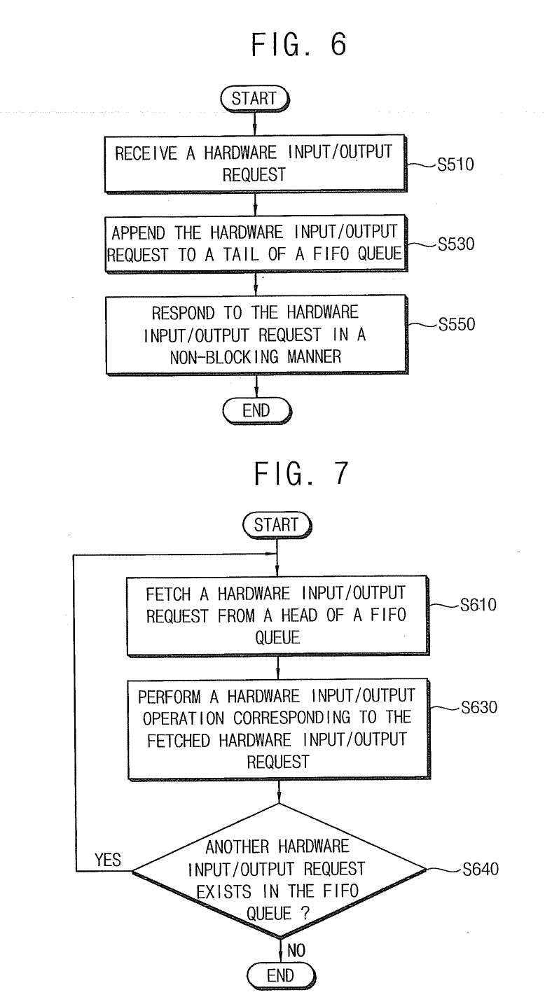

FIG. 6 is a flow chart illustrating an operation of a request manager included in a multi-core system of FIG. 5.

Referring to FIGS. 5 and 6, a request manager 270b receives hardware input/output requests RQ1, RQ2, RQ3 and RQ4 from first through fourth applications 211, 213, 215 and 217 (S510).

The request manager 270b appends the hardware input/output requests RQ1, RQ2, RQ3 and RQ4 to a hardware input/output list 280b, or a tail of a FIFO queue (S530). For example, in a case where first through fourth hardware input/output requests RQ1, RQ2, RQ3 and RQ4 are sequentially received, the request manager 270b may append the first hardware input/output request RQ1 to the FIFO queue, the second hardware input/output request RQ2 next to the first hardware input/output request RQ1, the third hardware input/output request RQ3 next to the second hardware input/output request RQ2, and the fourth hardware input/output request RQ4 next to the third hardware input/output request RQ3.

The request manager 270b responds to the hardware input/output requests RQ1, RQ2, RQ3 and RQ4 received from the first through fourth applications 211, 213, 215 and 217 in a non-blocking manner (S550). That is, if the request manager 270b receives the hardware input/output requests RQ1, RQ2, RQ3 and RQ4, the request manager 270b may not wait for the completion of hardware input/output operations corresponding to the hardware input/output requests RQ1, RQ2, RQ3 and RQ4, and may substantially immediately respond to the first through fourth applications 211, 213, 215 and 217. Accordingly, the first through fourth applications 211, 213, 215 and 217 may perform other operations, and the first and second processor cores 210b and 230b may efficiently operate.

FIG. 7 is a flow chart illustrating an operation of a resource manager included in a multi-core system of FIG. 5.

Referring to FIGS. 5 and 7, a resource manager 290b fetches a hardware input/output request from a hardware input/output list 280b, or a FIFO queue (S610). For example, the resource manager 290b may fetch a first hardware input/output request RQ1 located at a head of the FIFO queue.

The resource manager 290b controls a hardware device 250 to perform a hardware input/output operation corresponding to the fetched hardware input/output request (S630). For example, if the first hardware input/output request RQ1 is fetched, the resource manager 290b may perform a hardware input/output operation corresponding to the fetched first hardware input/output request RQ1 with the hardware device 250.

If another hardware input/output request exists in the FIFO queue (S640: YES), the resource manager 290b fetches the another hardware input/output request from the head of the FIFO queue (S610), and may perform a hardware input/output operation corresponding to the fetched hardware input/output request with the hardware device 250 (S630). For example, if the hardware input/output operation corresponding to the first hardware input/output request RQ1 is performed, second through fourth hardware input/output requests RQ2, RQ3 and RQ4 may exist in the FIFO queue. In this case, the resource manager 290b may sequentially fetch the second through fourth hardware input/output requests RQ2, RQ3 and RQ4, and may sequentially perform hardware input/output operations corresponding to the second through fourth hardware input/output requests RQ2, RQ3 and RQ4.

In some embodiments, if the FIFO queue is empty (S640: NO), the resource manager 290b may be terminated. The resource manager 290b may be executed again when a new hardware input/output request is appended to the hardware input/output list 280b. In other embodiments, the resource manager 290b may substantially reside in the second processor core 230b, and may be terminated when the multi-core system 200b is terminated.

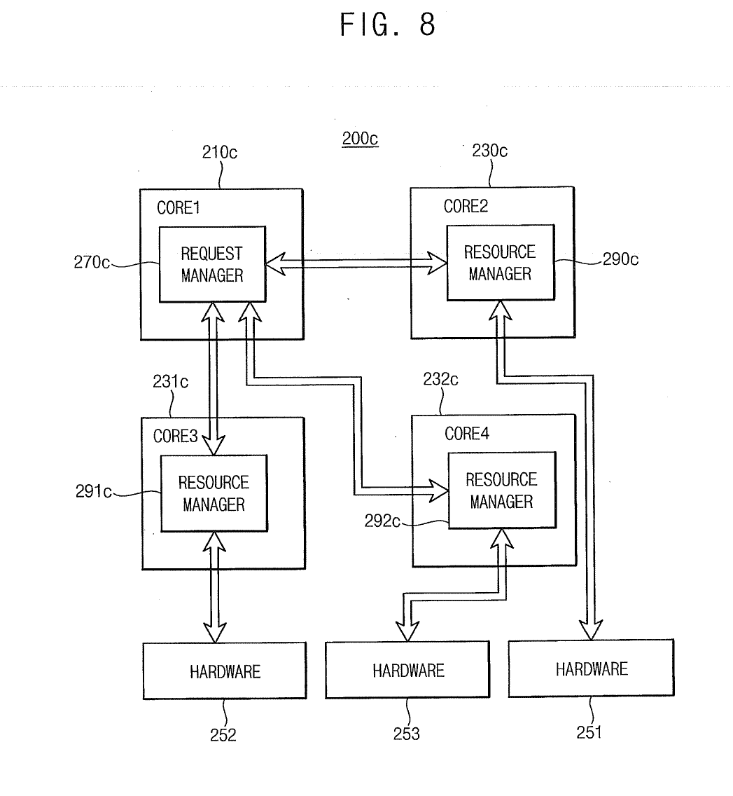

FIG. 8 is a block diagram illustrating a multi-core system according to example embodiments.

Referring to FIG. 8, a multi-core system 200c includes first through fourth processor cores 210c, 230c, 231c and 232c and first through third hardware devices 251, 252 and 253.

The first through fourth processor cores 210c, 230c, 231c and 232c may execute a plurality of applications. The first processor core 210c may execute a request manager 270c that communicates with the plurality of applications. The request manager 270c may include a hardware input/output list to manage hardware input/output requests for the first through third hardware devices 251, 252 and 253. In some embodiments, the hardware input/output list may be a linked list, a FIFO queue, or the like.

In some embodiments, the request manager 270c may include a single hardware input/output list with respect to all the hardware devices 251, 252 and 253. In other embodiments, the request manager 270c may include a plurality of hardware input/output lists respectively corresponding to the first through third hardware devices 251, 252 and 253.

The second through fourth processor cores 230c, 231c and 232c may execute first through third resource managers 290c, 291c and 292c to perform input/output operations for the first through third hardware devices 251, 252 and 253, respectively. For example, the second processor core 230c may execute the first resource manager 290c to perform the input/output operation for the first hardware device 251, the third processor core 231c may execute the second resource manager 291c to perform the input/output operation for the second hardware device 252, and the third processor core 232c may execute the third resource manager 292c to perform the input/output operation for the third hardware device 253. Each resource manager 290c, 291c and 292c may control one or more hardware devices 251, 252 and 253.

As described above, since the request manager 270c is executed by the first processor core 210c, and the first through third resource managers 290c, 291c and 292c for performing the input/output operations for different hardware devices are executed by the second through fourth processor cores 230c, 231c and 232c, respectively, the management of the hardware input/output requests, the input/output of the first hardware device 251, the input/output of the second hardware device 252 and the input/output of the third hardware device 253 may be processed in parallel. Accordingly, a performance of the multi-core system 200c may be improved.

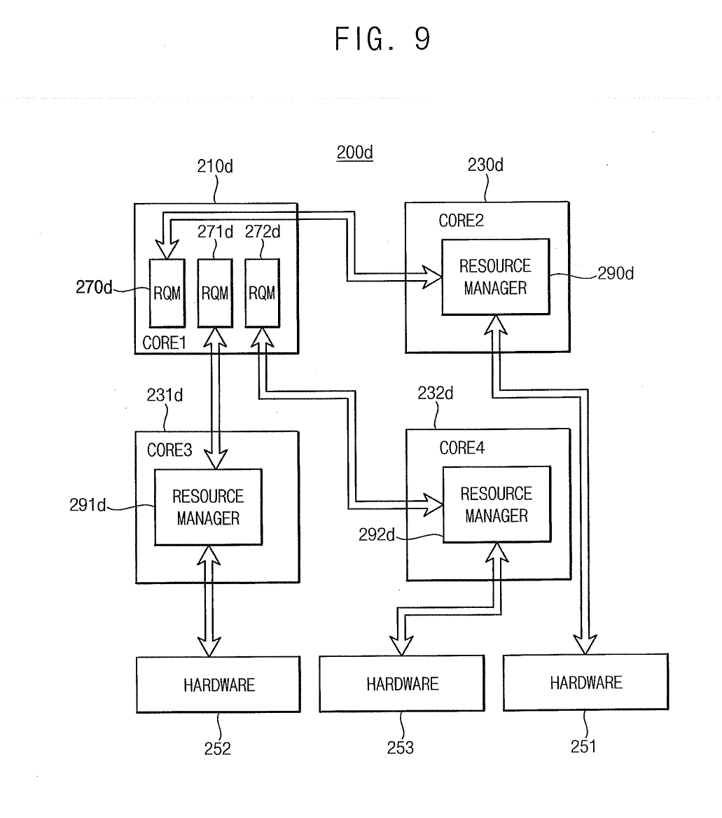

FIG. 9 is a block diagram illustrating a multi-core system according to example embodiments.

Referring to FIG. 9, a multi-core system 200d includes first through fourth processor cores 210d, 230d, 231d and 232d and first through third hardware devices 251, 252 and 253.

The first through fourth processor cores 210d, 230d, 231d and 232d may execute a plurality of applications. The first processor core 210d may execute first through third request managers 270d, 271d and 272d that communicate with the plurality of applications. The first through third request managers 270d, 271d and 272d may include first through third hardware input/output lists to manage hardware input/output requests for the first through third hardware devices 251, 252 and 253, respectively. For example, the first request manager 270d may manage hardware input/output requests for the first hardware device 251 using the first hardware input/output list, the second request manager 271d may manage hardware input/output requests for the second hardware device 252 using the second hardware input/output list, and the third request manager 272d may manage hardware input/output requests for the third hardware device 253 using the third hardware input/output list. In some embodiments, each of the first through third hardware input/output lists may be a linked list, a FIFO queue, or the like.

The second through fourth processor cores 230d, 231d and 232d may execute first through third resource managers 290d, 291d and 292d to perform input/output operations for the first through third hardware devices 251, 252 and 253, respectively. For example, the first resource manager 290d executed by the second processor core 230d may fetch the hardware input/output requests from the first request manager 270d, and may perform the input/output operations for the first hardware device 251. The second resource manager 291d executed by the third processor core 231d may fetch the hardware input/output requests from the second request manager 271d, and may perform the input/output operations for the second hardware device 252. The third resource manager 292d executed by the fourth processor core 232d may fetch the hardware input/output requests from the third request manager 272d, and may perform the input/output operations for the third hardware device 253. Each resource manager 290d, 291d and 292d may control one or more hardware devices 251, 252 and 253.

As described above, since the first through third request managers 270d, 271d and 272d are executed by the first processor core 210d, and the first through third resource managers 290d, 291d and 292d corresponding to the first through third request managers 270d, 271d and 272d are executed by the second through fourth processor cores 230c, 231c and 232c to perform the input/output operations for different hardware devices, respectively, the management of the hardware input/output requests, the input/output of the first hardware device 251, the input/output of the second hardware device 252 and the input/output of the third hardware device 253 may be processed in parallel. Accordingly, a performance of the multi-core system 200d may be improved.

Although FIGS. 2 and 5 illustrate examples of a multi-core system including two processor cores, and FIGS. 8 and 9 illustrate examples of a multi-core system including four processor cores, the multi-core system according to example embodiments may include two or more processor cores. For example, the multi-core system according to example embodiments may be a dual-core system, a quad-core system, a hexa-core system, etc.

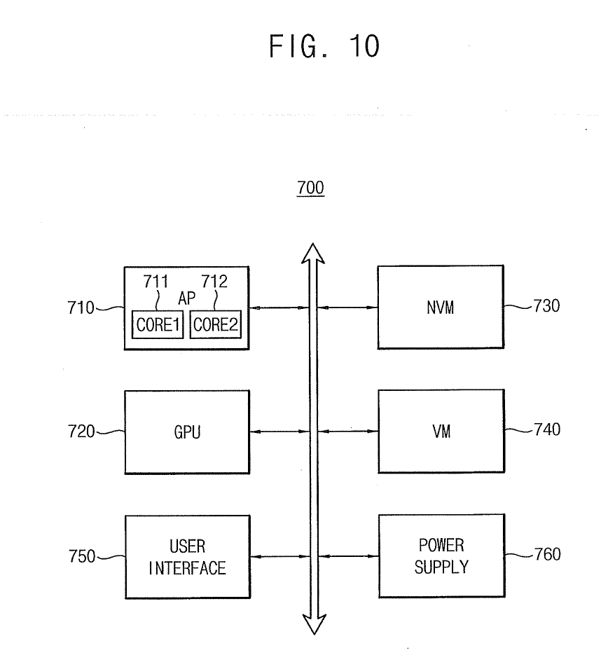

FIG. 10 is a block diagram illustrating a mobile system according to example embodiments.

Referring to FIG. 10, a mobile system 700 includes an application processor 710, a graphic processing unit (GPU) 720, a nonvolatile memory device 730, a volatile memory device 740, a user interface 750 and a power supply 760. According to example embodiments, the mobile system 700 may be any mobile system, such as a mobile phone, a smart phone, a personal digital assistant (PDA), a portable multimedia player (PMP), a digital camera, a portable game console, a music player, a camcorder, a video player, a navigation system, etc.

The application processor 710 may include a first processor core 711 and a second processor core 712. The first and second processor cores 711 and 712 may execute applications, such as an internet browser, a game application, a video player application, etc. The applications may request input/output operations for hardware devices, such as the GPU 720, the nonvolatile memory device 730, the volatile memory device 740, the user interface 750, etc. The first processor core 711 may manage hardware input/output requests received from the applications, and the second processor core 712 may perform hardware input/output operations corresponding to the hardware input/output requests. Accordingly, the first processor core 711 and the second processor core 712 may efficiently operate, and a performance of the mobile system 700 may be improved. In some embodiments, the first and second processor cores 711 and 712 may be coupled to an internal or external cache memory. The first and second processor cores 711 and 712 may have the same structure and operation of any of the processor cores discussed above with reference to FIGS. 1-9. For example, the first processor core 711 may have the same structure and operation of the either of the processor cores 210a or 210b discussed above with reference to FIGS. 2 and 5, respectively. As another example, the second processor 712 may have the same structure and operation of the either of the processor cores 230a or 230b discussed above with reference to FIGS. 2 and 5, respectively.

The GPU 720 may process image data, and may provide the processed image data to a display device (not shown). For example, the GPU 720 may perform a floating point calculation, graphics rendering, etc. According to example embodiments, the GPU 720 and the application processor 710 may be implemented as one chip, or may be implemented as separate chips.

The nonvolatile memory device 730 may store a boot code for booting the mobile system 700. For example, the nonvolatile memory device 730 may be implemented by an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), a ferroelectric random access memory (FRAM), or the like. The volatile memory device 740 may store data processed by the application processor 710 or the GPU 720, or may operate as a working memory. For example, the nonvolatile memory device 740 may be implemented by a dynamic random access memory (DRAM), a static random access memory (SRAM), a mobile DRAM, or the like.

The user interface 750 may include at least one input device, such as a keypad, a touch screen, etc., and at least one output device, such as a display device, a speaker, etc. The power supply 760 may supply the mobile system 700 with power.

In some embodiments, the mobile system 700 may further include a camera image processor (CIS), and a modem, such as a baseband chipset. For example, the modem may be a modem processor that supports at least one of various communications, such as GSM, GPRS, WCDMA, HSxPA, etc.

In some embodiments, the mobile system 700 and/or components of the mobile system 700 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP).

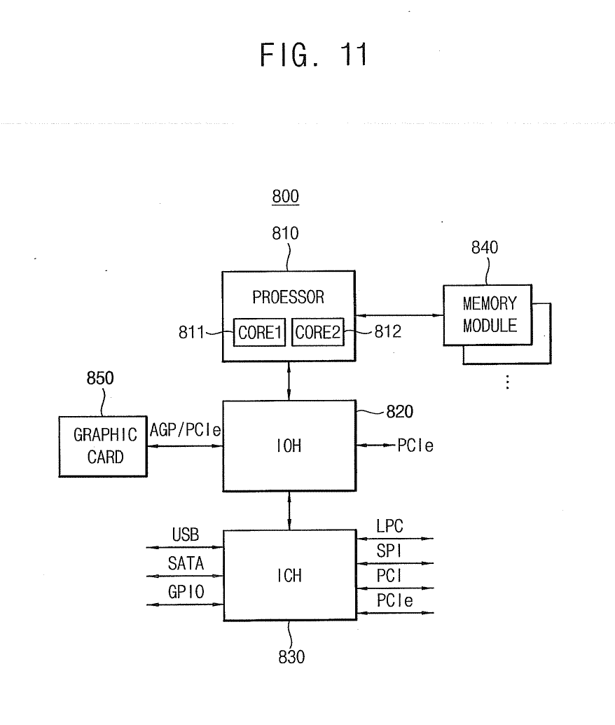

FIG. 11 is a block diagram illustrating a computing system according to example embodiments.

Referring to FIG. 11, a computing system 800 includes a processor 810, an input/output hub 820, an input/output controller hub 830, at least one memory module 840 and a graphic card 850. In some embodiments, the computing system 800 may be any computing system, such as a personal computer (PC), a server computer, a workstation, a tablet computer, a laptop computer, a mobile phone, a smart phone, a personal digital assistant (PDA), a portable multimedia player (PMP), a digital camera, a digital television, a set-top box, a music player, a portable game console, a navigation device, etc.

The processor 810 may perform specific calculations or tasks. For example, the processor 810 may be a microprocessor, a central process unit (CPU), a digital signal processor, or the like. The processor 810 may include a first processor core 811 and a second processor core 812. The first and second processor cores 811 and 812 may execute applications, and the applications may request input/output operations for hardware devices, such as the memory module 840, the graphic card 850, or other devices coupled to the input/output hub 820 or the input/output controller hub 830. The first processor core 811 may manage hardware input/output requests received from the applications, and the second processor core 812 may perform hardware input/output operations corresponding to the hardware input/output requests. Accordingly, the first processor core 811 and the second processor core 812 may efficiently operate, and a performance of the computing system 800 may be improved. In some embodiments, the first and second processor cores 811 and 812 may be coupled to an internal or external cache memory. Although FIG. 11 illustrates an example of the computing system 800 including one processor 810, the computing system 800 according to example embodiments may include one or more processors. The first and second processor cores 811 and 812 may have the same structure and operation of any of the processor cores discussed above with reference to FIGS. 1-9. For example, the first processor core 811 may have the same structure and operation of the either of the processor cores 210a or 210b discussed above with reference to FIGS. 2 and 5, respectively. As another example, the second processor 812 may have the same structure and operation of the either of the processor cores 230a or 230b discussed above with reference to FIGS. 2 and 5, respectively.

The processor 810 may include a memory controller (not shown) that controls an operation of the memory module 840. The memory controller included in the processor 810 may be referred to as an integrated memory controller (IMC). A memory interface between the memory module 840 and the memory controller may be implemented by one channel including a plurality of signal lines, or by a plurality of channels. Each channel may be coupled to at least one memory module 840. In some embodiments, the memory controller may be included in the input/output hub 820. The input/output hub 820 including the memory controller may be referred to as a memory controller hub (MCH).

The input/output hub 820 may manage data transfer between the processor 810 and devices, such as the graphic card 850. The input/output hub 820 may be coupled to the processor 810 via one of various interfaces, such as a front side bus (FSB), a system bus, a HyperTransport, a lightning data transport (LDT), a QuickPath interconnect (QPI), a common system interface (CSI), etc. Although FIG. 11 illustrates an example of the computing system 800 including one input/output hub 820, in some embodiments, the computing system 800 may include a plurality of input/output hubs.

The input/output hub 820 may provide various interfaces with the devices. For example, the input/output hub 820 may provide an accelerated graphics port (AGP) interface, a peripheral component interface-express (PCIe), a communications streaming architecture (CSA) interface, etc.

The graphic card 850 may be coupled to the input/output hub 820 via the AGP or the PCIe. The graphic card 850 may control a display device (not shown) for displaying an image. The graphic card 850 may include an internal processor and an internal memory to process the image. In some embodiments, the input/output hub 820 may include an internal graphic device along with or instead of the graphic card 850. The internal graphic device may be referred to as an integrated graphics, and an input/output hub including the memory controller and the internal graphic device may be referred to as a graphics and memory controller hub (GMCH).

The input/output controller hub 830 may perform data buffering and interface arbitration to efficiently operate various system interfaces. The input/output controller hub 830 may be coupled to the input/output hub 820 via an internal bus. For example, the input/output controller hub 830 may be coupled to the input/output hub 820 via one of various interfaces, such as a direct media interface (DMI), a hub interface, an enterprise Southbridge interface (ESI), PCIe, etc. The input/output controller hub 830 may provide various interfaces with peripheral devices. For example, the input/output controller hub 830 may provide a universal serial bus (USB) port, a serial advanced technology attachment (SATA) port, a general purpose input/output (GPIO), a low pin count (LPC) bus, a serial peripheral interface (SPI), a PCI, a PCIe, etc.

In some embodiments, the processor 810, the input/output hub 820 and the input/output controller hub 830 may be implemented as separate chipsets or separate integrated circuits. In other embodiments, at least two of the processor 810, the input/output hub 820 and the input/output controller hub 830 may be implemented as one chipset. A chipset including the input/output hub 820 and the input/output controller hub 830 may be referred to as a controller chipset, and a chipset including the processor 810, the input/output hub 820 and the input/output controller hub 830 may be referred to as a processor chipset.

As described above, since the first processor core 811 may manage the hardware input/output request, and the second processor core 812 may perform the hardware input/output operations, the hardware input/output operations may be efficiently performed, and a performance of the entire system 800 may be improved.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

1. A method of processing requests for hardware in a multi-core system including a first processor core and a second processor core, the method comprising:
receiving, at the first processor core, a plurality of hardware input/output requests from a plurality of applications;
managing, at the first processor core, the plurality of hardware input/output requests using a hardware input/output list;
responding, at the first processor core, to the plurality of hardware input/output requests in a non-blocking manner; and
sequentially processing, at the second processor core, the plurality of hardware input/output requests included in the hardware input/output list.

2. The method of claim 1, wherein the hardware input/output list includes a plurality of linked lists respectively corresponding to the plurality of applications, and the plurality of linked lists are linked to one another.

3. The method of claim 2, wherein managing the plurality of hardware input/output requests comprises:
if a new hardware input/output request is received from one of the plurality of applications, appending the new hardware input/output request to a corresponding one of the plurality of linked lists.

4. The method of claim 2, wherein managing the plurality of hardware input/output requests comprises:
if a new application is executed, adding a new linked list corresponding to the new application to the plurality of linked lists.

5. The method of claim 2, wherein sequentially processing the plurality of hardware input/output requests comprises:
selecting a linked list from the plurality of linked lists;
fetching a hardware input/output request included in the selected linked list; and
performing a hardware input/output operation corresponding to the fetched hardware input/output request.

6. The method of claim 5, wherein fetching the hardware input/output request comprises:
fetching a head of the selected linked list; and
removing the head of the selected linked list.

7. The method of claim 5, wherein fetching the hardware input/output request and performing the hardware input/output operation are repeated until the selected linked list becomes empty.

8. The method of claim 5, wherein sequentially processing the plurality of hardware input/output requests further comprises:
if the selected linked list becomes empty, selecting a next linked list to which the empty linked list is linked among the plurality of linked lists.

9. The method of claim 1, wherein the hardware input/output list includes a first-in first-out (FIFO) queue to manage the plurality of hardware input/output requests in a FIFO manner.

10. The method of claim 9, wherein managing the plurality of hardware input/output requests comprises:
if a new hardware input/output request is received, appending the new hardware input/output request to a tail of the FIFO queue.

11. The method of claim 9, wherein the plurality of hardware input/output requests are sequentially processed according to an input order of the plurality of hardware input/output requests.

12. The method of claim 11, wherein sequentially processing the plurality of hardware input/output requests comprises:
sequentially fetching the plurality of hardware input/output requests from the FIFO queue; and
performing hardware input/output operations corresponding to the fetched hardware input/output requests.

13. The method of claim 12, wherein sequentially fetching the plurality of hardware input/output requests comprises:
fetching a head of the FIFO queue; and
removing the head of the FIFO queue.

14-15. (canceled)

16. A method of handling input/output (I/O) requests for hardware received at a multi-core system, the multi-core system including a first processor core and a second processor core, the method comprising:
listing the received I/O requests in a first request list using the first processor core;
obtaining at least one of the listed I/O requests from the first request list using the second processor core; and
executing an I/O operation indicated by the at least one I/O request obtained from the first request list using the second processor core.

17. The method of claim 16, wherein the received I/O requests are each associated with at least one of a plurality of applications,
listing the received I/O requests includes forming a plurality of request lists respectively corresponding to a plurality of applications,
the plurality of request lists includes the first request list, and
the plurality of request lists are linked to one another.

18. The method of claim 17 wherein listing the received I/O requests includes, for each of the received I/O requests, selecting, from among the plurality of request lists, a request list based on an application associated with the received I/O request, and listing the received I/O request in the selected request list.

19. The method of claim 16 further comprising:
for each of the received I/O requests, responding, at the first processor core, to the received I/O request without waiting for an I/O operation indicated by the received I/O request to be executed.

20. The method of claim 16 wherein listing the received I/O requests is performed by the first processing core and not the second processing core.
